(19) United States
(12) Patent Application Publication
(10) Pub. No.: US 2014/0081689 A1
(43) Pub. Date: Mar. 20, 2014

(54) WORK ASSIGNMENT THROUGH MERGED SELECTION MECHANISMS

(71) Applicant: AVAYA INC., Basking Ridge, NJ (US)

(72) Inventors: Robert C. Steiner, Broomfield, CO (US); Andrew D. Flockhart, Thornton, CO (US); Joylee Kohler, Colorado Springs, CO (US); Gene Masaru Uba, Broomfield, CO (US)

(73) Assignee: AVAYA INC., Basking Ridge, NJ (US)

(21) Appl. No.: 13/623,763

(22) Filed: Sep. 20, 2012

(51) Int. Cl. G06Q 10/06

(52) U.S. Cl. 705/7.15

(57) ABSTRACT

A contact center is described along with various methods and mechanisms for administering the same. In particular, work assignment methods are disclosed that are configured to utilize multiple selection mechanisms in determining an optimal work assignment. By analyzing data relating to agent selection, queue information, and state information, of one or more contact centers, a work item may be efficiently assigned to achieve a work item optimal solution. In some cases, the optimal solution for a work item may be contrary to an optimal solution for a particular contact center. However, the primary goal of efficiently handling the work item via one or more resources can be achieved by merging selection mechanisms and intelligently assigning work items on a system-wide basis.

### FIELD OF THE DISCLOSURE

The present disclosure is generally directed toward communications and more specifically toward contact centers.

### BACKGROUND

Contact centers can provide numerous services to customers, and have been doing so for years. The idea of a contact center queue is not much different from that of standing in line at a bank and waiting to be helped by the next available teller. However, there can be a lot of frustration if the first, second, or even third teller cannot answer a given question or set of questions. The same frustrations have been known to occur in contact centers. A company can gain customer satisfaction if they are able to answer their customers' questions quickly and accurately.

Contact centers, such as Automatic Call Distribution or ACD systems, are employed by many enterprises to service customer contacts. A typical contact center includes a switch and/or server to receive and route incoming packet-switched and/or circuit-switched contacts and one or more resources, such as human agents and automated resources (e.g., Interactive Voice Response (IVR) units), to service the incoming contacts.

As products and problems become more complex and diverse in nature, a single agent often no longer has all of the skills or expertise to fully service customer contacts. To service customer contacts more effectively, the contact center may route contacts to one or more resources with specific skills and attributes. For example, contact centers that handle computer customer service may have application resources, hardware resources, operating system resources, network resources, etc. While these resources may be well-qualified to answer questions on their particular subject(s), they are often unqualified to answer questions involving subjects outside of their respective skill sets.

Currently, resources may be assigned work based on a number of factors that are considered by a selection mechanism. These factors may include, but are not limited to resource availability, agent training and/or skill, contact center state, contact type, and more. A specific selection mechanism may be applied to route work items based on, agent selection, queue selection, attribute selection or other desired mechanism. It is one goal of a contact center to maintain good customer service when handling contacts, and as such, many mechanisms have been developed to best distribute work to qualified agents in a timely and efficient manner. However, the work assignment mechanism of a contact center employs only one type of selection mechanism at a time in assigning work items. In some cases contacts may not be assigned to the most qualified agent or resource, especially with skill-specific contacts or high-demand contact center states.

### SUMMARY

It is with respect to the above issues and other problems that the embodiments presented herein were contemplated. In general, embodiments of the present disclosure provide methods, devices, and systems to automatically receive, analyze, and assign a work item to a resource determined from the application of multiple, merged, selection mechanisms. By applying multiple selection mechanisms to a work item, optimal work assignments may be made on a system-wide basis. In some embodiments, the system may include one or more resources, where each resource may represent an agent, group, queue, site, contact center, and combinations of work handling entities. Among other things, the present disclosure provides methods, devices, and systems to merge multiple selection mechanisms together in assigning work items to resources by, among other things, considering agent selection, site selection, and queue selection as a complete system to achieve optimal work assignments. Work assignments may be made utilizing the multiple selection mechanisms in real-time, near-real-time, and/or non-real-time. Furthermore, it is anticipated that the work assignments may be performed online and/or offline to suit the processing needs of the contact center.

In some embodiments, the present disclosure utilizes multiple selection mechanisms together to assign work items on a system-wide and work item optimal basis. In particular, a work item may be routed by a work assignment mechanism based on an optimal routing generated by using two or more merged selection mechanisms. For instance, agents, queues, and sites may all be viewed as resources and can be assigned attributes. These attributes may include, but are not limited to, languages spoken, media channels supported, what products or services are supported, and the like. For attributes that are agent specific like occupancy and idle time, for queues and sites the occupancy of the least occupied agent and the idle time of the agent with the longest idle time may be used. In other cases, like handle time, quality scores, or revenue, the average for all agents in the queue or site for the metric may be used. Once the metrics are normalized, agents may be compared to queues and sites to make the best match. As disclosed herein, the merged selection mechanisms may be applied in real-time, near-real-time, and/or non-real-time.

By way of example, a work item may be received at a work assignment mechanism of a first contact center where it may be routed according to standard work selection mechanism rules. If a traditional queue selection mechanism is used, then it may be determined that the optimal routing of the work item (e.g., utilizing a queue selection mechanism alone) is when the work item is assigned to a first queue in a first contact center. Although, this assignment may be considered optimal for the queue-based assignment mechanisms of the first contact center, it may not be the optimal assignment for the work item, or the system. In contrast, if the same work item is received at a first contact center where it is to be routed according to the merged selection mechanisms described herein, the result may be entirely different. For instance, the work item may be assigned according to both queue selection and site selection. Therefore, the merged mechanisms may evaluate a work assignment for both mechanisms and determine an optimal assignment of the work item based on the optimal routing for the work item considering both queue and site selection. In other words, the optimal merged solution may be that the work item is routed to a second contact center, also known as outsourcing. In some embodiments, the work item may be pre-assigned to a queue in the second contact center. Additionally or alternatively, the work item may be sent to the work assignment engine of the second contact center for further routing. As can be appreciated, the work item may be coded to indicate processing rules, routing history, application of selection mechanisms, and the like.

In some embodiments, a merged selection module may receive at least one of state information, agent selection information, and queue information from one or more contact centers. This resource information may be stored remotely from, or outside of, the work assignment mechanism. Additionally, or alternatively, the information may be stored locally within a memory of a contact center. In one embodiment, the resource information may be stored as data in a table, bitmap, or at least one other database. In some cases, the data may be updated at times to maintain accurate resource information. The update of resource information may be achieved via any one or more of the modes disclosed herein.

It is an aspect of the present disclosure that the resource information may be used to intelligently assign work items on a system-wide basis. In one embodiment, the merged selection module may request this resource information from one or more resources as needed to perform a work assignment. In other words, the merged selection module may “pull” the resource information from one or more resources regarding at least one of state information, agent selection, and queue information.

Additionally, or alternatively, the resource information may be “pushed” to the merged selection mechanism via one or more resources. For example, a first contact center may have received a first work item to be assigned by a first merged selection module. Before the work assignment is performed, the merged selection module may refer to a memory containing resource information to determine an optimal work assignment for the first work item. The memory may be updated via the one or more resources to reflect resource information changes to the one or more resources. For instance, in the event that a queue operating in the second contact center has changed, it may push an update to the memory reflecting this change. Determining what type of information changes require an update to the memory may be controlled by rules (e.g., business/enterprise rules, processing rules, cost-based algorithms, and the like).

In accordance with embodiments of the present disclosure, the resource information may be updated at a memory, database, or the like at predetermined intervals. For example, each resource may update its own resource information in the memory every 5, 10, and/or 30 minutes. It is anticipated that the predetermined periods may be configured by observing resource changes over time. In some cases, the merged selection module, work assignment mechanism, and/or a processor and memory, may automatically calculate an update interval based on historical data. This historical data may include, but is not limited to, requested updates from one or more merged selection modules. As can be expected, the historical data may be used online or offline, in near-real-time, or non-real-time, to compare a predetermined update interval to an observed efficiency of work assignments and even work item handling. This comparison may be used to automatically calculate a new update interval, change the update interval, and/or modify the mode of updating resource information (e.g., between two or more of push, pull, timed, and/or combinations thereof).

In some embodiments, the work assignment engine may run individual selection algorithms to determine work assignments and the merged selection module may compare information relating to solutions provided by the various selection algorithms in determining an optimal work assignment. As can be appreciated, the comparison of solutions and/or contact center, or site, states may be subject to stored rules. It is anticipated that these stored rules may determine conflict resolution, priority, wait time arrangement, and the like. The rules may be stored in at least one of a local memory (e.g., memory that is locally accessed within a work assignment mechanism, merged selection module, and/or contact center) and remote memory (e.g., a memory that is accessed via a communication network).

It should be appreciated that the present disclosure outlines utilizing multiple selection mechanisms together to assign work items on a system-wide optimal basis. By merging selection mechanisms, a work item may be assigned according to the optimal solution for the work item, which may be a suboptimal solution for a given contact center. Among other things, the present disclosure provides methods, devices, and systems to overcome the limitations of current contact centers that cannot merge selection mechanisms in assigning work items inside and/or outside of a contact center.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a first flow diagram depicting a method of assigning work items using merged selection mechanisms in accordance with embodiments of the present disclosure; and

FIG. 3 is a second flow diagram depicting a method assigning work items using merged selection mechanisms in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

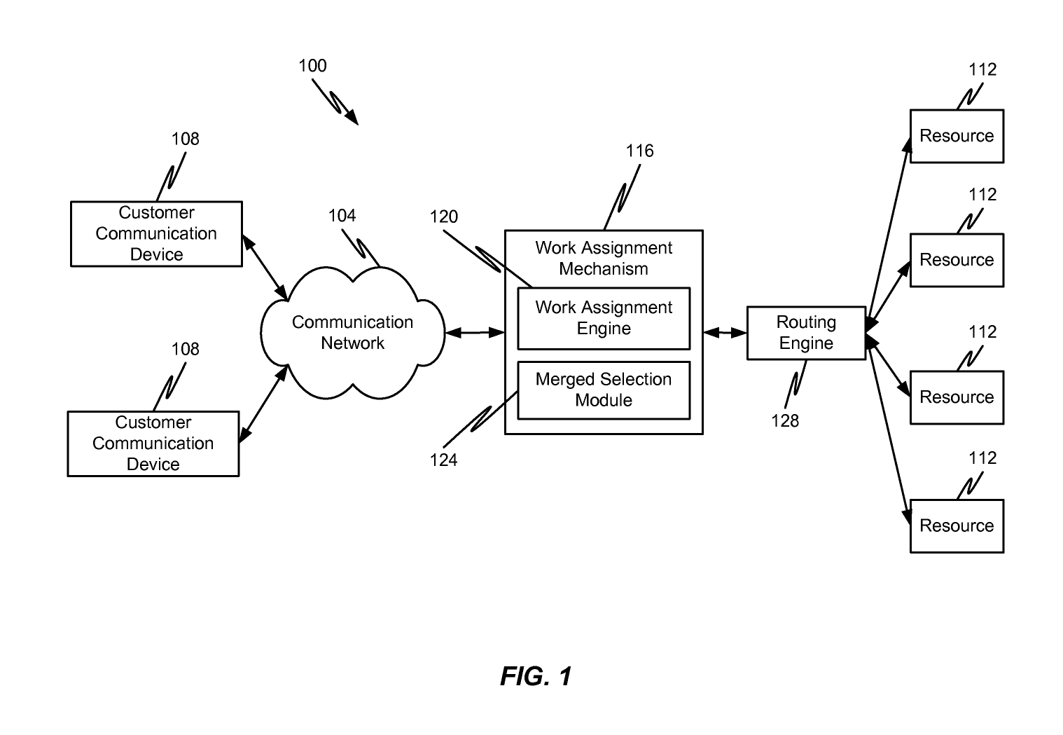

FIG. 1 shows an illustrative embodiment of a communication system 100 in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from the customer communication devices 108.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over Internet Protocol (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Exemplary work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof.

In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively, each of which are hereby incorporated herein by reference in their entirety.

The format of the work item may depend upon the capabilities of the communication device 108 and the format of the communication. In some embodiments, work items are logical representations within a contact center of work to be performed in connection with servicing a communication received at the contact center (and more specifically the work assignment mechanism 116).

Although the routing engine 128 is depicted as being separate from the work assignment mechanism 116, the routing engine 128 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 128.

The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers, and may include contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference.

More specifically, the work assignment engine 120 can determine which of the plurality of processing resources 112 is eligible and/or qualified to receive a work item and further determine which of the plurality of processing resources 112 is best suited to handle the processing needs of the work item. In situations of work item surplus, the work assignment engine 120 can also make the opposite determination (i.e., determine optimal assignment of a work item to a resource). In some embodiments, the work assignment engine 120 is configured to achieve true one-to-one matching.

The work assignment engine 120 may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

In addition to comprising the work assignment engine 120, the work assignment mechanism 116 may also comprise a merged selection module 124. As discussed above, the merged selection module 124 may be configured to receive and assign work items based at least partially on resource information and the application of multiple selection mechanisms. In some embodiments, the merged selection module 124 may assign work items to one or more resources 112 based on an optimal solution determined for the work item and/or contact center.

The merged selection module 124 may apply two or more selection mechanisms to a received work item in determining the optimal work assignment. In particular, a received work item may be subjected to a plurality of selection mechanisms in work assignment and the results of the plurality of selection mechanisms may be compared to determine the work item's optimal assignment. Each selection mechanism applied to a work item may be configured to utilize resource information received from one or more resources 112. Additionally, the merged selection module 124 may refer to rules in determining a work assignment solution for each of, and/or all of, the selection mechanisms applied. As can be appreciated, the comparison of results, resources 112, and/or contact center, or site, states may be subject to stored rules. It is anticipated that these stored rules may determine conflict resolution, priority, wait time arrangement, and the like. Once an appropriate work assignment is determined by the merged selection module 124, the routing engine may route the work item to the determined resource 112. As can be appreciated, routing provided by the routing engine 128 may be affected by direction provided by at least one of the work assignment mechanism 116, the work assignment engine 120, and the merged selection module 124. This direction may include input relative to resource 112 type, group type, customer identification, and the like.

In some embodiments, the merged selection module 124 may determine that the optimal work assignment of a work item is to route the work item from a first contact center to another contact center. In some instances, the work item may be routed to a contact center outside of the first contact center's enterprise. This type of routing is at least one example of outsourcing. Whether the work item is outsourced (inside or outside of an existing enterprise) the merged selection module 124 may determine that the work item should be managed by the work assignment mechanism 116 of the outsourced resource 112. For example, a first contact center may apply merged selection mechanisms to a work item where it is determined, by the merged selection module 124, to outsource the work item to a second contact center (which may be outside of the first contact center's enterprise network). Further, the merged selection module 124 may determine that the work item should be assigned according to the second contact center's work assignment rules/mechanism(s). This work assignment by the second contact center may be requested because of a limited amount of information provided to the merged selection module 124 via the second contact center. Additionally, or alternatively, the second contact center work assignment may be requested due to a detected first and/or second contact center state, special routing rules of the second contact center (i.e., the destination contact center), and/or compatibility issues surrounding work assignment and routing. In any event, the work item may be routed to the second contact center along with coded information to indicate that work assignment processing is required. In some embodiments, the work item may be routed to a resource where the coded information is added by the merged selection module 124.

As can be appreciated, the merged selection module 124 may add information to a work item to indicate a number of work assignment related data. This data may be maintained in a bitmap, table, or other digital form of memory that is associated with the work item. The data may include, but is not limited to, selection mechanisms used in work assignment processing, further processing required (including work assignment, routing, etc), time in work assignment (e.g., cumulative time or per work assignment mechanism 116 time), source resource, destination resource, and other work assignment related information.

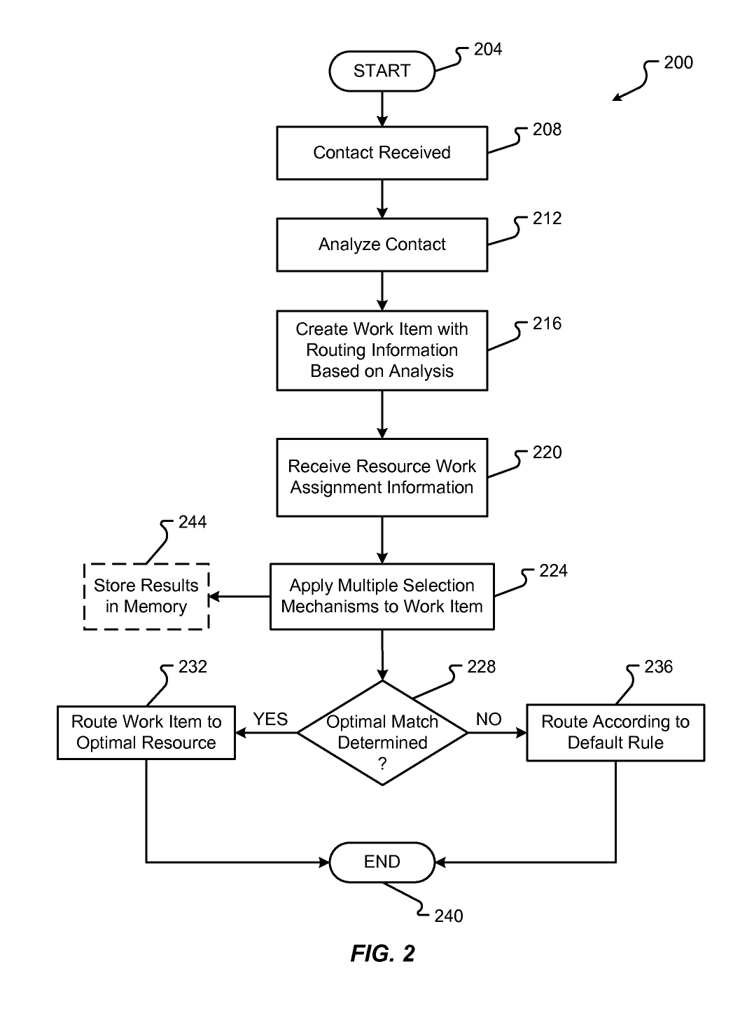

Referring now to FIG. 2, a first flow diagram is provided in accordance with embodiments of the present disclosure depicting a method 200 of assigning work items using merged selection mechanisms. The method 200 begins at step 204 and proceeds when a contact is received by the work assignment mechanism 116 of a contact center (step 208). Next, the contact may be analyzed for information relating to the contact type and other information that may be used to aid in the efficient routing within at least one workflow (step 212). This analysis may be performed by the work assignment mechanism 116, through its various components (e.g., the work assignment engine 120 and the merged selection module 124, etc.). Categories of information relating to the contact may include, but is not limited to, subject matter, urgency level, customer grade or level, applied selection mechanisms, requested resource(s), and workflow status, to name a few. In some embodiments, the work assignment mechanism 116 may direct a work item to the merged selection module 124 where multiple selection mechanisms may be applied in work assignment. In other words, some embodiments anticipate that the merged selection module 124 may be selectively activated/deactivated based on at least one of contact analysis, contact center state, administrative rules, and resource 112 availability. This selective activation/deactivation of the merged selection module 124 may be performed automatically (e.g., in response to the contact analysis or input provided by a customer, resource, and/or IVR).

In accordance with embodiments of the present disclosure, it is anticipated that the categories of information and other information related to a contact may be provided via manual input, automated processes, and/or combinations thereof. In one embodiment, the manual input may be provided by a customer who is requesting a resource. This manual input may be provided in response to one or more human agent and automated resource (e.g., IVR) prompts. Additionally or alternatively, the work assignment mechanism 116, upon receiving a contact, may automatically determine the contact source (via IP address, MAC address, and the like), associations, type, and customer. This data may be used to further determine prior contacts, historical data, customer quality levels, languages, geographic resources, and the like.

The method 200 continues by creating a work item based at least partially on the contact analysis performed (step 216). As described above, each received contact is analyzed for pertinent category information to aid in routing, queuing, and/or applying multiple selection mechanisms. Among other things, the work item may be created to include routing and/or attribute information that can be used by the merged selection module 124 when applying multiple selection mechanisms. As can be appreciated, the work assignment performed by the merged selection module 124 may include any number of mechanisms to route, queue, and/or direct work to one or more resources 112.

The merged selection module 124 may be configured to receive information relating to work assignment from a number of resources 112 (step 220). This resource information may be pushed to the merged selection module 124 or pulled from one or more resources 112. In some cases, the resource information may be obtained from one or more resources 112 and stored in memory. As disclosed herein, the memory may be updated to reflect changes to resource information. In some embodiments, the access to the resource information may be restricted according to associated resource 112 privileges. For example, a resource 112 may be assigned one or more privileges such as “read only,” “read/write,” “full-control,” and “administrative.” In one embodiment, a resource 112 may be assigned “full control” and/or “read/write” privileges concerning access to its own data and/or the ability to update its own resource information. It is anticipated that this resource 112 may have “read only” privileges concerning another resource's information. Among other things, protecting access and the control of information with assigned privileges can prevent unauthorized modifications to stored data, especially resource information.

In some embodiments, the resource information may relate to a resource's state and/or condition. For example, in the event of a contact center emergency, the contact center may provide resource information to any number of merged selection modules 124, locally or remotely, that may be used by each module 124 in determining emergency condition work assignments. In this example, the contact center in a state of emergency may not be capable of handling a typical number of work items. As such, the contact center's internal merged selection module 124 may direct work items to alternate contact centers for a time period relating to the time that the emergency condition is in place. Additionally, or alternatively, the contact center may update its resource information to indicate a work surplus condition, and deny incoming work assignments (e.g., from other merged selection modules). Conversely, at times of low contact center traffic, the contact center conditions may prompt the merged selection module 124 to direct work items within the contact center having a low traffic state. Alternatively, it may be deemed that work items and contacts can be handled more efficiently during low traffic conditions by outsourcing work items to other resources 112. As can be appreciated, the method 200 may be modified in various configurations to suit contact center and/or resource 112 allocation needs.

The method 200, upon receiving resource information, may continue by applying multiple selection mechanisms to the work item (step 224). Application of the multiple selection mechanisms may be performed via the merged selection module 124. In some embodiments, the merged selection module 124 may refer to the routing information of the work item in selecting appropriate resources 112 to include in the application of multiple work assignment mechanisms.

Typical selection mechanisms may be configured to route work items based on agent selection, queue selection, attribute selection, and the like. Each selection mechanism may be configured to consider specific resources 112, multiple resources 112, and/or a number of resources 112 based on resource information. As can be expected, solutions to each selection mechanism may utilize rules to determine at least one resource 112 that best matches the analyzed contact information (obtained in step 212). For example, a resource 112 may be associated with, inter alia, handling a specific subject matter type. Upon detecting that a work item is associated with the specific subject matter type a selection mechanism may output a result that matches the resource 112 with the work item. The merged selection module 124 may utilize the results obtained from two or more selection mechanisms in order to determine the optimal work assignment match.

In some embodiments, determining a work item and resource 112 match by a selection mechanism may be based on presence information. The presence information may relate to the presence of a resource 112, including, but not limited to a contact center, agent, group, device, and combinations thereof. Presence may be provided via multiple methods and/or standards including but not limited to Session Initiation Protocol (“SIP”), Instant Message and Presence Protocol (“IMPP”), Extensible Messaging and Presence Protocol (“XMPP”), and the like. In some embodiments, the use of presence may be employed to alter an availability of one or more resources 112. Although presence is more than availability, it is anticipated that the presence of multiple resources 112 in a contact center, upon reaching a predetermined threshold, may alter a contact center's state. For example, if it is determined based on presence information that 70% of a contact center's resources 112 are unable to handle a contact, the entire contact center may be classified as “utilized.” A resource 112 classified as “utilized” may be treated differently from other resources 112, especially when a selection mechanism is including one or more resources 112 to consider in providing a work assignment result. Moreover, the merged selection module 124 may consider presence, or associated indications, in determining whether an optimal match exists. It should be appreciated that this threshold may be adjusted as deemed appropriate, automatically via historical data and/or manually via preference settings within the merged selection module 124.

In accordance with embodiments of the present disclosure, it is anticipated that the merged selection module 124 may be used, inter alia, to qualify new, or test, selection mechanisms. In other words, the merged selection module 124 may incorporate the use of test selection mechanisms along with recognized and/or reliable selection mechanisms in routing work items. As can be appreciated, this process may be performed in real-time, near-real-time, and/or non-real-time. At least one embodiment anticipates storing the results of the merged selection module 123 in a memory 244. The memory may be located locally or remotely, and may be referred to at any time to refine the merged selection module 124, selection mechanisms, and/or provide historical data relating to work assignments.

In some embodiments, the merged selection module 124 analyzes the results provided by two or more selection mechanisms applied to a work item in determining an optimal resource 112 match. An optimal match may be made by the merged selection module 124 determining which selection mechanism result provides the best match of a work item and resource 112 on a work item and/or system-wide optimal basis. This optimal match, obtained by the merged selection mechanism 124, may not be optimal for the contact center applying the multiple selection mechanisms, but it may be optimal for the work item itself.

By way of example, a first work item may be created at a first contact center. During the application of multiple selection mechanisms, the first work item may be matched to at least one resource 112 using attribute and queue selection mechanisms. In this case, each selection mechanism (attribute and queue) may refer to routing and/or attribute information associated with the first work item. Once each selection mechanism has presented a result, the merged selection module 124 determines which result provides a system-wide optimal match. In the event that both selection modules have provided the same result (identical resource 112 to handle the work item), the merged selection module 124 does not need to select a winning mechanism. However, this data may be stored in a memory for further analysis or processing (step 244).

On the other hand, if the two selection mechanisms provide different results, the merged selection module 124 may be configured to determine a winning selection mechanism result (e.g., an optimal match). This determination may require the merged selection module 124, to refer to at least one of, resource information (e.g., including presence, availability, attributes, condition, and the like), work item information, enterprise rules, contact center rules, and the like. In some cases, the merged selection module 124 may utilize linear optimization programming/equations to determine an optimal result. In some embodiments, the solution determined may be optimal for a work item but not a specific resource. For instance, a merged selection module 124 may determine that routing a work item from a first contact center to a second contact center may save cost as well as decrease the handling time of the work item. Although the first contact center may be in a resource 112 surplus mode (e.g., more resources 112 available than work items), and an optimal solution for the first contact center may be to handle the call via an available resource 112 within the first contact center, the system-wide optimal routing decision is to route the work item to the second contact center. As can be appreciated, the merged selection module 124 may be configured to account for many variables to provide an optimal solution.

The method 200 continues by determining whether an optimal resource match has been determined by the merged selection module 124 (step 228). As previously stated, if no optimal match is determined (e.g., where the same result is provided by all selection mechanisms, a tie exists between solutions, or a condition is set to avoid an optimal match, etc.) the method will route the work item according to a predetermined, or default, rule (step 236). One example of a default rule may include routing to an internal (inside an enterprise) resource 112 before routing to an external (outsourced) resource 112. However, in the event that an optimal match is determined, the work item is routed according to the at least one optimal resource 112 (step 232). It is anticipated that the routing may be performed by the routing engine 128 in response to direction provided by at least one of the work assignment mechanism, work assignment engine 120, and merged selection module 124.

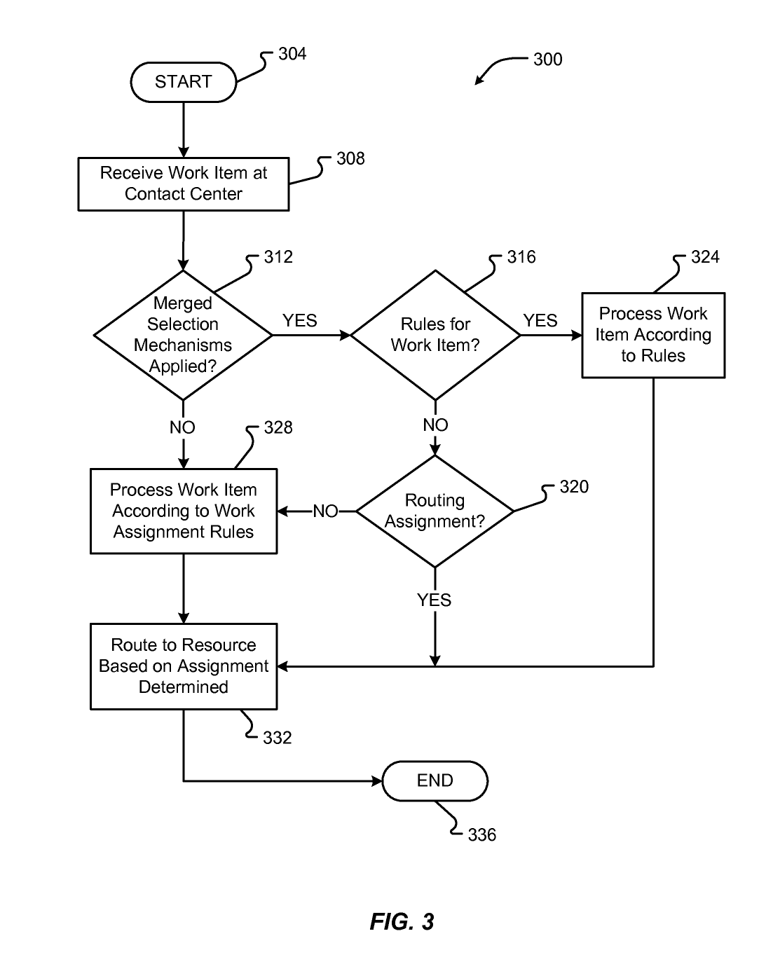

FIG. 3 is a second flow diagram depicting a method 300 of assigning work items using merged selection mechanisms in accordance with embodiments of the present disclosure. The method begins at step 304 and proceeds when a work item is received by a resource 112, e.g., a contact center (step 308). As presented in FIG. 3, the work item may be received by the contact center via any acceptable means including, but not limited to, regular workflow assignment, prior merged selection mechanism assignment (as disclosed in FIG. 2), and the like. Additionally, or alternatively, the work item may be newly received at the contact center.

The method 300 continues by the merged selection module 124 of the receiving contact center determining whether the work item has been routed via a merged selection module 124 (step 312). For example, a work item may have been forwarded to the contact center via another contact center that applied merged selection mechanisms to the work item. In some embodiments, the work item may include routing information, or some other indication (e.g., in the form of digital data associated with the work item) that it has been subjected to a prior merged selection module 124. As can be appreciated, the work item may be analyzed to review associated information that may include, but is not limited to, an identifier, skill and attributes set, assigned resource 112, and the like. If the work item is received by a contact center without having merged selection mechanisms applied, it may be directed to work assignment of the contact center (at step 328). In one example, a newly received work item at a contact center may be directed to step 328, for work assignment.

In some embodiments, the merged selection module 124 may determine that merged selection mechanisms have already been applied to the work item (e.g., by another resource 112, contact center, online/offline merged selection module 124, etc.), in which case, the method 300 will continue by determining whether the work item should be processed according to rules (step 316). Among other things, the rules may direct the receiving contact center to process the work item using its merged selection module 124. Additionally, or alternatively, the rules may direct the receiving contact center to directly route the work item to a specific resource 112. Another embodiment may direct the receiving contact center to process the work item as a regular work item, such as applying a single selection mechanism or work assignment mechanism. In any event, the work item may be suitably coded to indicate the rule, or rules, that the receiving resource 112 should apply. Such coding is anticipated to include an identifier with the work item. In one embodiment, the identifier may be contained in a “rules” field of a data structure that is associated with the work item. It is anticipated that the data structure may be represented in a digital binary format, using bits to represent specific rules and routing instructions. In some cases, the rules field may contain the rules that a receiving contact center can use in further processing. If it is determined that rules are associated with the work item, the method 300 may continue by processing the work item according to the associated rules (step 324). Upon processing the work item according to the rules, the work item may be routed to a resource 112 (step 332).

However, in the event that no rules are identified for the work item, the method 300 may proceed by determining whether the work item contains any routing assignment (step 320). The merged selection module 124, or work assignment mechanism 116, of the receiving contact center may detect that the work item is not associated with rules. By analyzing a specific data structure field, observing the absence of such a field, or interpreting an indicator/identifier, the module 124 or mechanism 116 can determine whether rules exist. As disclosed herein, a work item subjected to a merged selection module 124 may be coded with routing information. The routing information may include an assignment for at least one of a specific attribute, group, agent, queue, and resource 112. If a routing assignment is included with the work item the work item may be routed to the assigned resource 112 (step 332).

On the other hand, if no routing assignment is associated with the work item, the method 300 may continue by processing the work item according to work assignment rules of the receiving contact center (step 328). In some embodiments, the work assignment mechanism 116 of the receiving contact center may apply standard work assignment techniques, such as subjecting the work item to a single work assignment selection mechanism or one-to-one matching, and the like. In other embodiments, the work assignment mechanism 116 may direct the work item to a merged selection module 124, where the work item may be subjected to multiple selection mechanisms, as disclosed herein. Once the work item is assigned to a resource 112, the method 300 may continue by routing the work item to the assigned resource 112 (step 332). As can be appreciated, the work item may be routed via a routing engine 128 as disclosed herein. After the work item has been appropriately routed in accordance with the determined process, the method 300 ends (step 336).

It should be appreciated that while embodiments of the present disclosure have been described in connection with a queueless contact center architecture, embodiments of the present disclosure are not so limited. In particular, those skilled in the contact center arts will appreciate that some or all of the concepts described herein may be utilized in a queue-based contact center or any other traditional contact center architecture.

Furthermore, in the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

1. A method, comprising:
receiving a work item, wherein the work item represents a contact received at a first contact center;
applying, via a merged selection module configured as instructions stored in a non-transitory computer readable medium and executed by a processor and prior to assigning the work item, two or more work assignment selection mechanisms to the work item, wherein each of the two or more work assignment selection mechanisms is configured to provide one or more work assignment results for the work item; and
determining, via the processor, an optimal work assignment result selected from the provided one or more work assignment results, wherein the optimal work assignment result represents a best match for the work item to a resource on a system-wide basis, wherein the system includes more than one queue and contact center site.

2. The method of claim 1, wherein determining the optimal work assignment result further comprises:
receiving resource information from two or more resources, wherein the resource information includes, for each of the two or more resources, at least one of resource identification, attribute data, queue data, agent data, presence information, state, and condition;
comparing, via the processor, each of the one or more work assignment results provided by the two or more work assignment selection mechanisms with the resource information; and
selecting an optimal work assignment result based at least partially on the comparison, wherein the optimal work assignment result is at least one resource matched to the work item.

3. The method of claim 2, wherein selecting the optimal work assignment result further comprises:
referring to a state associated with the at least one resource, wherein the state represents a condition of operation of the resource, and wherein the condition of operation of the resource is considered, via the merged selection module, in selecting the optimal work assignment.

4. The method of claim 3, wherein selecting the optimal work assignment result further comprises:
removing, automatically from selection, the at least one resource with at least one of an emergency and work-surplus state.

5. The method of claim 1, wherein the one or more work assignment results are provided in near-real-time, and wherein the determination of the optimal work assignment result is performed in near-real-time.

6. The method of claim 2, wherein each of the one or more work assignment results provided by the two or more work assignment selection mechanisms is compared concurrently by the processor.

7. The method of claim 1, further comprising:
routing the work item to at least one resource, the at least one resource associated with the optimal work assignment result.

8. The method of claim 7, further comprising:
receiving the work item at the at least one resource, wherein the at least one resource is a second contact center; and
processing the work item in the second contact center.

9. The method of claim 8, wherein processing the work item further comprises:
determining that the work item received at the second contact center includes data associated with a merged selection module; and
routing the work item as directed by the included data.

10. The method of claim 8, wherein the second contact center applies, automatically two or more work assignment selection mechanisms to the work item.

11. A non-transitory computer readable medium having stored thereon instructions that, when executed by a processor, perform a method comprising:
receiving a work item, wherein the work item represents a contact received at a first contact center;
applying, via a merged selection module and prior to assigning the work item, two or more work assignment selection mechanisms to the work item, wherein each of the two or more work assignment selection mechanisms is configured to provide one or more work assignment results for the work item; and
determining an optimal work assignment result selected from the provided one or more work assignment results, wherein the optimal work assignment result represents a best match for the work item to a resource on a system-wide basis, wherein the system includes more than one queue and contact center site.

12. The non-transitory computer readable medium of claim 11, determining the optimal work assignment result further comprises:
receiving resource information from two or more resources, wherein the resource information includes, for each of the two or more resources, at least one of resource identification, attribute data, queue data, agent data, presence information, state, and condition;
comparing, via a processor, each of the one or more work assignment results provided by the two or more work assignment selection mechanisms with the resource information; and
selecting an optimal work assignment result based at least partially on the comparison, wherein the optimal work assignment result is at least one resource matched to the work item.

13. The non-transitory computer readable medium of claim 12, wherein the selecting step of the method further comprises:
referring to a state associated with the at least one resource, wherein the state represents a condition of operation of the resource, and wherein the condition of operation of the resource is considered, via the merged selection module, in selecting the optimal work assignment.

14. The non-transitory computer readable medium of claim 13, wherein the selecting step of the method further comprises:
removing, automatically from selection, the at least one resource with at least one of an emergency and work-surplus state.

15. The non-transitory computer readable medium of claim 11, wherein the one or more work assignment results are provided in near-real-time, and wherein the determination of the optimal work assignment result is performed in near-real-time.

16. The non-transitory computer readable medium of claim 12, wherein each of the one or more work assignment results provided by the two or more work assignment selection mechanisms is compared concurrently by the processor.

17. The non-transitory computer readable medium of claim 11, wherein method further comprises:
routing the work item to at least one resource, the at least one resource associated with the optimal work assignment result;
receiving the work item at the at least one resource, wherein the at least one resource is a second contact center;
processing the work item in the second contact center.

18. A contact center, comprising:
a memory;
a processor; and
a work assignment mechanism including:
a work assignment engine configured to compare attributes of work items in a work pool with attributes of resources in a resource pool and match the work items to resources based on the comparison of attributes; and
a merged selection module configured to apply, by the processor and prior to assigning the work item, two or more work assignment selection mechanisms to the work item, wherein each of the two or more work assignment selection mechanisms is configured to provide one or more work assignment results for the work item, determine, by the processor, an optimal work assignment result selected from the provided one or more work assignment results, wherein the optimal work assignment result represents a best match for the work item to a resource on a system-wide basis, wherein the system includes more than one queue and contact center site.

19. The contact center of claim 18, further comprising:
a routing engine, wherein the routing engine is configured to route the work item to the at least one resource.

20. The contact center of claim 18, further comprising:
a database, wherein the database is configured to store information associated with one or more resources, and wherein the merged selection module is configured to refer to the database in selecting the optimal work assignment.
